(19) United States
(12) Patent Application Publication
(10) Pub. No.: US 2006/0231037 A1
(43) Pub. Date: Oct. 19, 2006

(54) Feeder for weanling pigs

(76) Inventor: Paul Gross, Westbourne (CA)

Correspondence Address: ADE & COMPANY INC., P.O. BOX 28006 1795 HENDERSON HIGHWAY, WINNIPEG, MB, R2G1P0, CA

(21) Appl. No.: 11/105,588

(22) Filed: Apr. 14, 2005

(51) Int. Cl. A01K 5/00

(52) U.S. Cl. 119/52.1

(57) ABSTRACT

A feeder for piglets has a flat base tray resting on the floor surface with an outer wall on the base tray surrounding a central feed area of the base tray defined by an upstanding plastic tube. The piglet can step over the outer wall to locate its front feet inside to retain any dropped feed and reaches through holes in the tube. The tube forms a hopper and feed dispensing drop duct mounted on the tray at the central feed area with a mouth of the duct spaced from the tray by a distance to control the deposit of feed onto the tray within the tube. An agitator is operable by the piglets to prevent lodging of the feed in the duct or hopper.

This invention relates to a feeder designed primarily for weanling pigs for close control and low waste of expensive weanling feed.

### BACKGROUND OF THE INVENTION

The raising of hogs is becoming more specialized with attention given to each aspect of the process so as to maximize the efficiency in that aspect. One aspect which requires further attention is that of feeding the piglets immediately after weaning, particularly bearing in mind that there is pressure to wean the piglets as soon as possible so as to commence weight gain from higher productivity feed and to return the sow more quickly from the farrowing area for a new litter.

Attention has therefore been given to providing specialized feeding devices which can supply initial high cost weaning feed to the weanlings immediately after weaning. Feed of this type is carefully manufactured and thus of higher cost so that waste and losses of the feed should be avoided as much as possible.

One device designed particularly for feeding weanlings is that shown in U.S. Pat. No. 5,311,838 (Thomas) assigned to Gromaster Inc. and issued May 17, 1994. This provides a trough with an outer edge converging downwardly and inwardly toward a center conical section which the outer edge surrounds. Feed is dropped onto the top of the conical section and collects with water on the conical surface for taking by the animal.

Another type of feeder is shown in U.S. Pat. No. 5,758,598 (Rother) assigned to Hawkeye Steel products and issued Jun. 2, 1998 which discloses a simple tray with a cylindrical container which can be fastened to a floor.

However there remains opportunity for an improved feeder which is of simple and economic construction and yet assists in reducing feed loss.

### SUMMARY OF THE INVENTION

According to one aspect of the invention there is provided a feeder for piglets comprising:

a base tray for resting on the floor surface;

a wall on the base tray surrounding a central feed area of the base tray and extending upwardly to a top edge of the wall at a height at which the piglets can reach over the top edge to the central area to take feed therefrom;

and a feed dispensing member mounted on the tray at the central feed area and standing upwardly therefrom so as to define a feed containing hopper above the feed area for dropping feed into the feed area;

the feed dispensing member comprising a tube with a bottom end of the tube fastened to the base tray;

the tube having a plurality of holes defined therein at spaced positions around its periphery adjacent the tray of a size such that one of the piglets reaching over the top edge of the wall can insert its snout through a selected one of the holes into the interior of the tube to take feed therefrom;

the tube having an upper hopper portion with a hopper bottom wall mounted in the tube above the holes with a duct extending downwardly in the tube from the hopper bottom wall to the tray for depositing feed onto the tray;

a mouth of the duct being spaced from the tray by a distance to control the deposit of feed onto the tray within the tube.

Preferably the duct is coaxial of the tube.

Preferably the tube is a plastic tube.

Preferably the tray is fastened to an end face of the tube by screws through the tray into the end face.

Preferably the hopper bottom wall is frusto-conical and is formed from metal fastened to an inside surface of the tube.

Preferably there is provided a plastic ring fastened to the inside wall of the tube at the top edge of the hopper bottom wall.

Preferably there is provided an agitator comprising a member at the tray movable by the piglets with a rod extending from the member through the duct into the hopper with an agitator element at the top of the rod so as to allow the piglets engaging the member at the tray to agitate the feed in the duct and in the hopper to prevent lodging.

Preferably there is provided a collar on the tube which is manually movable along the tube to change the height of the plurality of holes through which the piglets can reach into the feed area at the bottom of the tube.

Preferably the wall on the base tray surrounds the tube and the central feed area therein and extends upwardly to a top edge of the wall at a height at which the piglets can step over the top edge to place their front feet over the outer wall and take feed from to the central area.

According to a second aspect of the present invention there is provided a feeder for piglets comprising:

a base tray for resting on the floor surface;

and a feed dispensing member mounted on the tray at the central feed area and standing upwardly therefrom so as to define a feed containing hopper above the feed area for dropping feed into the feed area;

the feed dispensing member comprising a plastic tube with a bottom end face of the tube fastened to the base tray by screws through the tray into the end face;

the tube having a plurality of holes defined therein at spaced positions around its periphery adjacent the tray of a size such that one of the piglets can insert its snout through a selected one of the holes into the interior of the tube to take feed therefrom;

the tube having an upper hopper portion with a hopper bottom wall mounted in the tube above the holes with a duct extending downwardly in the tube from the hopper bottom wall to the tray for depositing feed onto the tray;

a mouth of the duct being spaced from the tray by a distance to control the deposit of feed onto the tray within the tube.

According to a third aspect of the present invention there is provided a feeder for piglets comprising:

a base tray for resting on the floor surface defining a generally horizontal surface from which the piglet can take feed;

a containing wall defining a central feed area of the base tray into which the piglets can reach for taking feed therefrom, the containing wall being shaped and arranged to confine the feed inwardly thereof;

a feed containing hopper above the feed area for dropping feed into the feed area;

an outer wall on the base tray surrounding the containing wall and the central feed area therein and extending upwardly to a top edge of the outer wall at a height at which the piglets can step over the top edge to place their front feet over the outer wall and take feed from to the central area.

### BRIEF DESCRIPTION OF THE DRAWINGS

One embodiment of the invention will now be described in conjunction with the accompanying drawings in which:

FIG. 1 is a cross sectional view through a feeder according to a present invention.

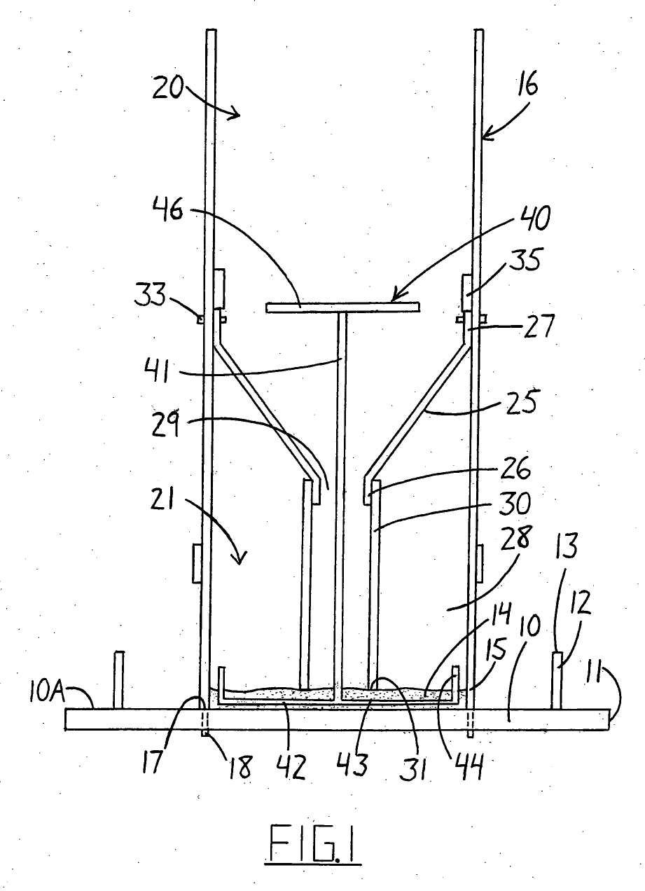

FIG. 2 is a top plan view of the feeder of FIG. 1.

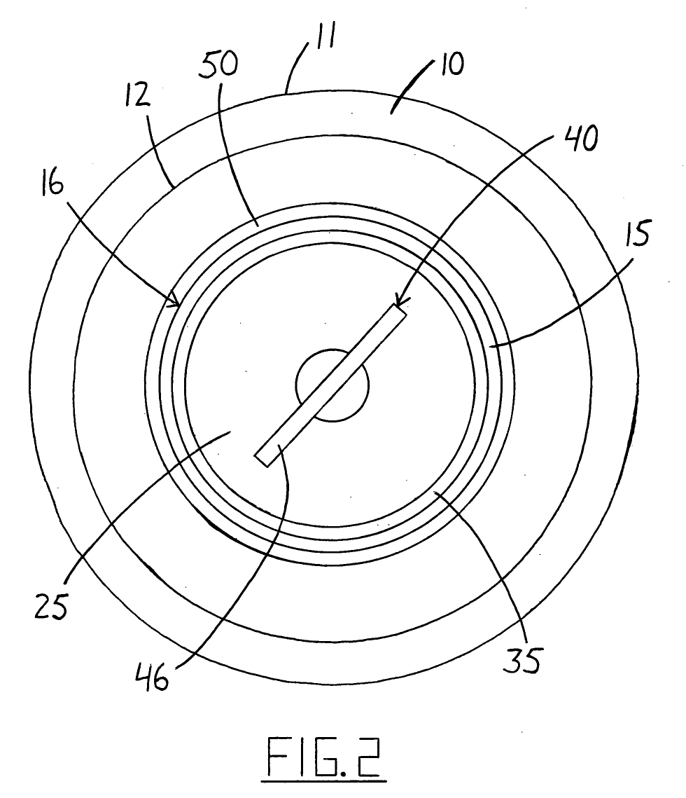

FIG. 3 is an isometric view of the feeder of FIG. 1.

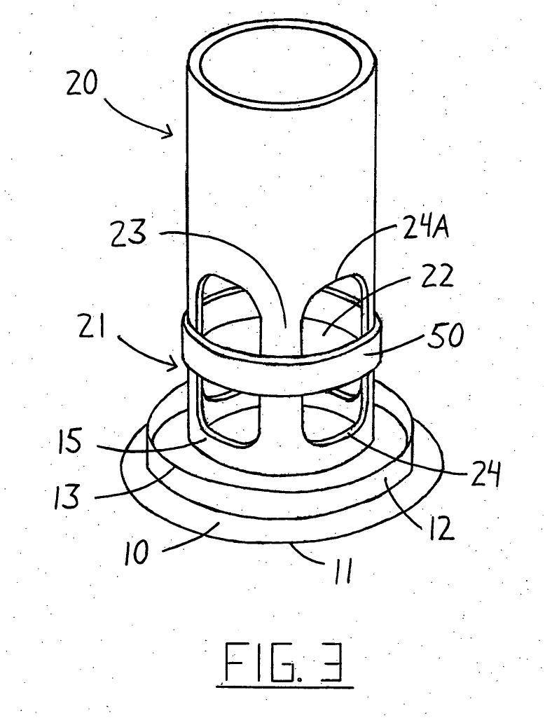

In the drawings like characters of reference indicate corresponding parts in the different figures.

### DETAILED DESCRIPTION

The feeder shown in the drawings comprises a flat base tray 10 formed of a sheet of metal which is circular in plan. At a position spaced inwardly from an outer edge 11 of the base plate is provided an upstanding cylindrical wall 12. This is welded to the base plate as a circular ring spaced inwardly from the edge 11 and concentric with the plate itself. The height of the wall 12 is such that it defines a top edge 13 which the piglet can reach over and which the piglet can step over so that's it front feet are located inwardly of the wall. The top edge 13 thus is low enough so that the belly of the pig is not uncomfortably engaging the top edge to allow the animal to straddle the outer wall 12.

A central feed area 28 of the tray contains feed 14 which the animal can reach with its front feet over the wall 12 so that its snout can reach into the central area 28 for taking the feed 14. The feed 14 is contained within an inner containing wall 15 which is also circular and concentric with the tray and with the outer wall 12. The inner wall 15 forms part of a plastic tube 16 which is fastened to the tray. The plastic tube is simply commercially available as a cylindrical tube which can be cut to length and cut to provide the arrangements and shaping described hereinafter. A flat bottom face 17 of the tube 16 is fastened to the base plate 10 by screw fasteners 18 which pass through holes in the base plate and extend through the end face 17 of the tube and into the wall of the tube thus engaging the wall of the tube and holding the end face flush against the upper surface 10A of the plate 10. The tube 16 defines a hopper section 20 at the upper end and a feeding section 21 at the lower end. The feeding section 21 is defined by a series of holes 22 through the wall of the tube leaving wall sections 23 to provide a structural support between the inner wall portion 15 at the bottom and the hopper section 20 at the top. The inner wall section is thus defined by a band below the bottom edge 24 of the holes 22. The feed is thus confined within the band forming the wall 15. The holes 22 are thus arranged so that the piglet can reach with its snout through the respective hole to access the feed in the central feed area 28 inwardly of the wall 15. Thus the piglet reaches through a hole and primarily feeds with its snout inside the wall 15. If however the piglet tends to reach back or step back and drop feed from its mouth, there is a tendency for the feed to be retained inside the outer wall 12 and thus be still available to be eaten to avoid waste.

The hopper section 20 is defined by the wall of the tube together with a hopper bottom 25 which is fastened to the wall of the tube and extends downwardly and inwardly to a bottom opening 29. The hopper bottom 25 is formed from metal and includes an upper collar 27 which is fastened on the inside surface of the wall of the tube. From that collar 27 the hopper bottom extends downwardly and inwardly to the bottom collar 26 which projects downwardly from the opening 29 at the bottom of the hopper wall. The collar 26 fastens to a pipe or duct 30 which extends downwardly toward the upper surface 10A of the tray but is spaced from the upper surface so that a bottom edge 31 of the duct 30 is at a fixed distance from the surface 10A.

The collar 27 is fastened to the wall of the tube by screws 33 which pass through the collar and the wall. Thus the metal hopper bottom formed by the collar 27, the frusto conical hopper bottom itself and the collar 26 is simply fastened inside the plastic tube 16 thus supporting the duct 30 at its spaced position from the surface 10A. Any feed in the hopper section thus falls downwardly to the opening 29 and through the duct 30 to the feed area 28. Excess feed is prevented from spilling by the cooperation of the repose angle of the particulate material, the surface 10A and the inside surface of the inner wall 15. Even though the repose angle of the feed material may therefore vary, a fixed spacing of the bottom of the duct can accommodate different types of feed without any of the feed being lost out of the central feed area 28 over the wall 15.

A collar 35 is attached by adhesive onto the inside surface of the tube 16 just above the collar 27 so as to prevent the feed material from entering behind the collar 27 since this is merely screw fastened to the inside surface of the tube 16.

An agitator 40 is provided which comprises a rod 41 extending downwardly along the duct 30. At the bottom of the rod 41 is provided one or more outwardly extending arms 42, 43 with an upwardly extending engagement portion 44 at its outer end. Thus the arms 42 and 43 tend to lie across the surface 10A with the portions 44 just inward of the wall 15. The animal reaching over the wall 15 can thus engage the arm 42, 43 or the upwardly extending portion 44 with its snout and move this back and forth thus tending to twist the rod 41 about its longitudinal axis. At the top of the rod is provided a cross bar 46 which simply extends across the hopper bottom as a loose fit so that twisting movement of the rod tends to twist the cross bar within the feed. This movement is sufficient to prevent the feed from lodging at the mouth of the hopper bottom, within the duct and also at the space between the bottom edge 31 and the surface 10A. It will be appreciated that the feed can become sticky in some circumstances with a tendency to bridge or lodge. In the circumstance that the animal is receiving no feed, it quickly learns to operate the agitator so that the feed then falls and becomes available for eating.

The feeder is intended for use by piglets from a very early stage of weaning through its early stages of growth to a maximum weight of the order of 30 pounds. Thus the holes 22 extend from a bottom edge 24 to a top edge 24A with the height sufficient for the largest animal to reach into the feed area 28 to take the feed. However it is desirable to ensure that smaller animals are prevented from entering fully into the central area 28 by stepping in through the holes. For this purpose a collar 50 is provided which wraps around the outside of the tube at a position partway up the holes 22. Thus when the animals are small just after weaning, the collar is moved downwardly so as to present to them a lower part only of the holes 22 so that they can reach in with their snout but are prevented from entering by the position of the collar just above their neck. As the animals grow larger, the collar 50 can be moved upwardly by a simple sliding action over the outside surface so that the operator adjusts the size of the hole underneath the collar in accordance with the size of the animals with which the feeder is being used.

Thus the intention is that the animals eat with their front feet over the outer wall 12 and their snout through the hole 22 at its lower part taking feed from the central area 28 and leaving the feed in that central area 28 until the animal pulls its snout rearwardly. Any material dropping from the snout remains inside the outer wall 12 and thus remains available for eating and is not despoiled by reaching the floor outside of the tray.

The feeder is of simple economic construction formed by simple cutting of sheet metal, minor welding steps to form the base tray and the hopper bottom and by screw fastening and the components together. The device requires no adjustment apart from the simple movement of the collar and can accommodate feeds of different consistency.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A pedicure boot comprising:
a) a sole member having a forward end;
b) an upper member operatively engaged to the sole member to form a foot receiving space, said upper member having a forward end releasably engageable to the forward end of the sole member while a remaining portion of the upper member remains engaged to the sole member, said forward end of the upper member being movable from a first position in engagement with the forward end of the sole member to a second position disengaged from the forward end of the sole member to thereby expose a toe portion of a user's foot; and
c) a first attachment means for releasably engaging the forward end of the upper member to the forward end of the sole member in said first position.

2. The pedicure boot of claim 1 further comprising a engagement means for engaging the forward end of the upper member to another position on the upper member while the upper member is in the second position disengaged from the sole member.

3. The pedicure boot of claim 1 further comprising a rear portion having an opening for receiving the foot of the user, said rear portion comprising a second attachment assembly for reversibly disengaging the rear portion into separate components to form a longitudinally disposed opening enabling the user to facilitate inserting the foot into the pedicure boot.

4. The pedicure boot of claim 3 wherein the upper member and the sole member are permanently attached to each other on at least one side of the pedicure boot between the rear portion and the forward ends of the upper member and sole member.

5. The pedicure boot of claim 3 wherein the upper member and the sole member are permanently attached to each other on both sides of the pedicure boot.

6. The pedicure boot of claim 3 wherein the upper member and the sole member are permanently attached to each other on one side of the pedicure boot.

7. The pedicure boot of claim 2 wherein the engagement means comprises a first engaging device positioned on the forward end of the upper member and a second corresponding engaging device positioned rearwardly of the first engaging device wherein when the first and second engaging devices are engaged together, the forward end of the upper member is in said second position.

8. The pedicure boot of claim 1 wherein the forward end of the upper member further comprises a rigid member extending upwardly from the first attachment means to thereby maintain the forward end of the upper member out of contact with the toes when the upper member is in the first position.

9. A pedicure boot comprising:
a) a sole member having a forward end and a side portion;
b) an upper member operatively engaged to the sole member to form a foot receiving space, said upper member having a forward end and a side portion releasably engageable to the forward end and side portion of the sole member while a remaining portion of the upper member remains engaged to the sole member said forward end of the upper member being movable from a first position in engagement with the forward end of the sole member to a second position disengaged from the forward end of the sole member to thereby expose a toe portion of the user's foot; and
c) first attachment means for releasably engaging the forward end and the side portion of the upper member to the forward end and side portion of the sole member in said first position.

10. The pedicure boot of claim 1 further comprising toe spacers in the foot receiving space for separating the toes from each other.

11. A pedicure boot comprising:
a) a sole member having a forward end; and
b) an upper member operatively engaged to the sole member to form a foot receiving space, said upper member having a forward end movable from a position exposing the toes to another position in which the toes are not exposed while the upper member remains attached to the sole member.
